(19) United States
(12) Patent Application Publication
(10) Pub. No.: US 2010/0326609 A1
(43) Pub. Date: Dec. 30, 2010

(54) Rainstopper - The Sunroof Shield

(76) Inventor: Thomas James Sheridan, Oakland, CA (US)

Correspondence Address: Thomas James Sheridan, 5229 1/2 Claremont Ave, Oakland, CA, 94618, US

(21) Appl. No.: 12/386,159

(22) Filed: Apr. 14, 2009

(51) Int. Cl. B60J 10/04

(52) U.S. Cl. 160/370.21

(57) ABSTRACT

The problem with sunroofs on vehicles, is that they sometimes leak, as mine does. I tried various forms of quick fixes, besides having it fixed correctly and more expensively. One day, after the tin foil I used blew off (it actually sticks when the roof is wet) I began thinking what could possibly exist that was durable and would ‘stick’ to the roof. This is when I thought up my idea of the The Rainstopper-Sunroof Shield.

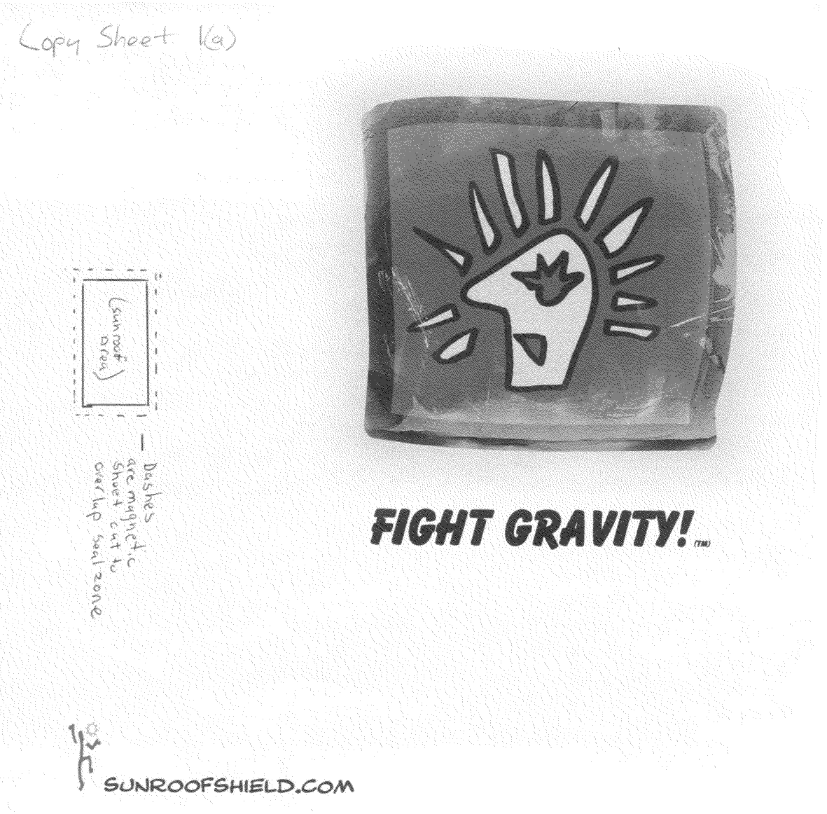

Using a flexible magnetic sheet, I was able to fabricate a shape that would cover the seal zone of the sunroof. Then with the help of the magnetic properties of the sheet, the roof now had a covering that would stick in place and help prevent major leaks during a windy rainstorm & downpour.

The specific improvement of this device is the new application for the use of the flexible magnetic sheets. Currently, they are used primarily for sign making/business advertising purposes.

### BACKGROUND OF THE INVENTION

This invention originated from a leaking sunroof issue, where an existing product (flexible magnetic sheets) can be custom fit and utilized to help generate a seal around the sunroof of a vehicle, thus preventing leaks.

### BRIEF SUMMARY OF THE INVENTION

A water leak prevention device to be utilized on a vehicle's sunroof.

### BRIEF DESCRIPTION OF THE SEVERAL VIEWS OF THE DRAWING

Copysheet 1(a) details a copy of the water leak device when labeled Sunroofshield.com and how it will look from the topside of the magnetic sheet. For instance, a magnetic sheet, varying in size from ⅛ inch to ½ inch in size will be cut custom to the one to two inch overlap of the sunroof seal zone, with this included graphic labeling the cut sheet.

### DETAILED DESCRIPTION OF THE INVENTION

Using a flexible magnetic sheet (readily available in the market-varying in size from ⅛ inch to ½ inch in size will be cut custom to the one to two inch overlap), I am able to fabricate a shape that would cover the seal zone of the sunroof. Then with the help of the magnetic properties of the sheet, the roof now had a covering that would stick in place and help prevent water leakage during a rain event. By custom cutting the sheet with a one to two inch overlap of the sunroof zone, a new solution to a leaking sunroof can be offered.

The specific improvement of this device is the new application for the use of the flexible magnetic sheets. Currently, they are used primarily for sign making/business advertising purposes.

1. My claim is that by implementing a new use for an existing material (flexible magnetic sheets), an individual may utilize my device to help prevent leaks from rain/snow events due to their sunroof/moonroof malfunctioning/leaking. The magnetic sheet, when custom cut with a one to two inch overlap of the sunroof zone (Space between the metal roof and the sunroof seal), will create an enhanced barrier. This will help repel significant amounts of rainwater from penetrating and coming into direct contact with the damaged sunroof/moonroof rubber seal area. The water will drain off the vehicle instead of draining inside through the bad seals of the sunroof. The magnetic property helps the maintain contact to the vehicle.
